(19) United States
(12) Patent Application Publication
(10) Pub. No.: US 2008/0070192 A1
(43) Pub. Date: Mar. 20, 2008

(54) Palladium-cobalt based alloys for dental prestheses including porcelain fused to metal

(75) Inventors: Tridib Dasgupta, E. Amherst, NY (US); Clyde Ingersoll, Tonawanda, NY (US); George Tysowsky, E. Amherst, NY (US)

Correspondence Address: BUCHANAN, INGERSOLL & ROONEY PC, POST OFFICE BOX 1404, ALEXANDRIA, VA, 22313-1404, US

(73) Assignee: Ivoclar Vivadent, Inc., Amherst, NY (US)

(21) Appl. No.: 11/543,917

(22) Filed: Oct. 6, 2006

Related U.S. Application Data
(60) Provisional application No. 60/844,672, filed on Sep. 15, 2006.

(51) Int. Cl. A61C 5/08

(52) U.S. Cl. 433/222.1; 433/218

(57) ABSTRACT

An alloy s provided for dental prostheses including porcelain fused to metal (PFM) restorations. The alloy is grey in color with an oxide coating for bonding porcelain to the oxidized cast alloy substrate. The alloy has suitable mechanical properties for cast prostheses and for the support of the porcelain and is readily polished to a bright sheen. The alloy is based on a palladium-cobalt binary system, has a coefficient of thermal expansion (CTE) in the range of about 14.0 to 15.3 and may include one or more of the following additive metals: aluminum, boron, chromium, gallium, lithium, rhenium, ruthenium, silicon, tantalum, titanium, and tungsten.

This application claims the benefit under 35 USC 119 (e) of provisional application No. 10/844,672, filed Sep. 15, 2006.

### FIELD OF THE INVENTION

This invention provides a novel palladium-cobalt based alloy intended for use in making cast metal dental restorations and, in particular, for alloy-porcelain (porcelain fused to metal (“PFM)) restorations.

### SUMMARY OF THE INVENTION

An aspect of the present invention is to provide an alloy which can be manufactured by the normal melt process, cast into a bar and rolled to the required thickness or alternatively, by the atomization and compression method of U.S. Pat. No. 5,799,386 to Ingersoll et al. entitled Process Of Making Metal Castings, issued Sep. 1, 1998, which is herein incorporated by reference in its entirety.

Another aspect of the present invention is to provide an alloy which has a solidus high enough that no fusion occurs during firing of normal porcelains.

Another aspect of the present invention is to provide an alloy which has a CTE in a range that has been shown to be compatible with porcelains.

Another aspect of the present invention is to provide an alloy which can be readily cast by normal dental procedures, and can be recast using normal dental laboratory procedures.

Another aspect of the present invention is to provide a cast alloy unit which can be ground and polished to a high shine.

Another aspect of the present invention is to provide an alloy which has a light oxide color that does not affect the apparent color of the porcelain layer and the oxide does not increase during the firing of the porcelain.

Another aspect of the present invention is to provide an alloy which when heated to the porcelain firing temperature, a thin, continuous, tenacious oxide is formed which enters into a bond with the porcelain.

Another aspect of the present invention is to provide an alloy which has the strength to withstand loads in excess of those that would cause pain to the patient.

The alloy of the invention is a palladium-cobalt binary alloy wherein palladium is about 20 to 90 wt % and cobalt is about 10 to 80 wt % . The coefficient of thermal expansion (CTE) is in the range of about 14.0 to 15.3. To the base Pd/Co alloy is added from 0 wt. % up to about 20 wt % of the following metals: aluminum, boron, chromium, gallium, lithium, rhenium, ruthenium, silicon, tantalum, titanium, tungsten or combinations thereof, to improve physical, chemical, mechanical and handling properties.

Another aspect of the present invention is to provide an alloy including 27 to 30 wt. % Pd, 55 to 58 wt. % Co, 8 to 11 wt. % Cr, 2.5 to 4 wt. % W, 1 to 2.5 wt. % Ga and less than 1 wt. % Al, Si, B, Li, or combinations thereof.

Another aspect of the present invention is to provide a dental restoration including a dental porcelain composition fused to dental alloy, the alloy including from 20 to 90 wt. % Pd, 10 to 80 wt % Co and 0 to 20 wt. % aluminum, boron, chromium, gallium, lithium, rhenium, ruthenium, silicon, tantalum, titanium, tungsten or combinations thereof.

These and other aspects of the present invention will become apparent upon a review of the following detailed description and accompanying examples which are recited herein as illustrative of the present invention but in no way limit the present invention.

### BACKGROUND OF THE INVENTION

Since the late 1950s, dental crowns, bridges, and the like have been made with a composite including a cast metal substrate with a veneer of porcelain fabricated in such a manner that there is a bond between metal and porcelain such that the composite is stronger than the individual component parts. There are several aspects to be addressed when formulating such composites.

Aesthetics is one aspect to be considered. The primary reason for the use of such a composite is to reproduce the normal coloration of natural dentition. The enamel layer of healthy natural dentition is quite translucent and porcelain can be made with equal translucency. The translucency of enamel allows the color of healthy dentine to be seen. The dentine color normally has a yellowish tint. For a porcelain/alloy combination to be effective as a composite, a layer of oxide must be present on the alloy to form a bond with the porcelain. While high gold alloys may provide a suitable yellowish background for the porcelain for proper aesthetics, the alloying elements can form a dark gray to black colored oxide layer, which can screen out this underlying yellowish background color. Moreover, larger amounts of alloying elements form a colored oxide layer that can further reduce or eliminate the underlying gold color of the alloy.

Mechanical properties are another aspect to be considered. The American National Standards Institute/American Dental Association (“ANSI/ADA”) specification #38 and International Organization for Standardization (“ISO”) standard IS9693 require a yield strength of at least 250 megapascal (“MPa”) for the alloy. To attain such strength in gold-based alloys, significant amounts of alloying elements must be added, the result being alloys of “yellow” color that are nearer to gray. It was thought necessary to provide great strength because the alloy supported porcelain, which had little strength, particularly in tension, and zero ductility. Any slight deformation of the metal can cause fracture of the porcelain layer. The minimum for the standards mentioned were set on the basis of testing alloys that were being successfully used at the time of the development of the standards. Subsequently, the minimum requirement has been questioned since alloys with less than this minimum have been used successfully. Also, it has been shown that the minimum requirement for single crowns should be lower than that for crowns composed of three or more unit bridges.

An unpublished work at the University of Kiel in Germany has indicated that from 30 to 35 kilograms of force causes pain to patients while, in one instance, 75 kilograms of force caused fracture of the tooth.

Physical properties are another aspect to be considered. Although the above-mentioned standards do not require either minimum or maximum values for the coefficient of thermal expansion (“CTE”), these standards require that the CTE value be given for both porcelain and alloy. This is because the popular conception is that the coefficients of porcelain and metal should be “matched” in order to assure compatibility of the two. This concept fails to take into consideration that stresses between the two occur during cooling rather than during heating and the cooling rates of porcelain and metal vary very significantly.

It is readily understood that the solidus of the alloy must be sufficiently higher than the firing temperature of the porcelain so that the alloy is not even partially melted during firing of the porcelain.

Chemical properties are another aspect to be considered. The bonding of porcelain to metal does not occur directly between porcelain and metal; rather it occurs between porcelain and the metal oxide layer. Normal PFM procedure is to heat the cast alloy to a suitable temperature to produce a metal oxide layer on the surface of the alloy. If this oxide is not adherent to the alloy; it can be simply removed by its attachment to the porcelain. Some of the bond is simply mechanical but the primary bonding takes place as a mutual solution of metal oxide in porcelain and vice versa. If the oxide is not soluble in the porcelain and/or vice versa, no bonding takes place. When the porcelain is fired, small particles and larger particle surfaces are fused (melted) and this liquid porcelain and the metal oxide layer form a solution by either liquid or solid diffusion.

### DETAILED DESCRIPTION OF THE INVENTION

There are several properties exhibited by the alloy(s) of the present invention that make it suitable for porcelain fused to metal (PFM) applications. The alloy is grey in color with an oxide coating for bonding porcelain to the oxidized cast alloy substrate. The alloy has mechanical properties for cast prostheses and for the support of the porcelain and is readily polished to a bright sheen. The alloy is based on a portion of the palladium-cobalt binary system wherein palladium is about 20 to 90 wt % and cobalt is about 10 to 80 wt % to obtain a coefficient of thermal expansion (CTE) in the range of about 14.0 to 15.3. To the base Pd/Co alloy is added up to about 20 wt % of the following metals: aluminum, boron, chromium, gallium, lithium, rhenium, ruthenium, silicon, tantalum, titanium, tungsten or combinations thereof, to improve physical, chemical, mechanical and handling properties. The alloy of the invention has a solidus high enough that no fusion occurs during firing of normal porcelains and a coefficient (CTE) in a range that has been demonstrated to be compatible with porcelains.

The alloy of the invention can be readily cast by normal dental procedures, and can be recast using normal dental laboratory procedures. The cast alloy unit can be ground and polished to a high shine. The alloy has a light oxide color that does not affect the apparent color of the porcelain layer and the oxide does not increase during the firing of the porcelain. When heated to the porcelain firing temperature, a thin, continuous, tenacious oxide is formed, which enters into a bond with the porcelain. The alloy has strength that withstands loads in excess of those that would cause pain to the patient.

The alloy of the present invention meets the aesthetic needs while using a palladium-cobalt base. That is, the alloy system reproduces the normal coloration of natural dentition. The enamel layer of healthy natural dentition is quite translucent and porcelain can be made with similar translucency. The translucency of enamel allows the color of healthy dentine to be seen. This color normally has a yellowish tint. With the porcelain alloy combination, a layer of oxide must be present to form a bond with the porcelain. While high gold alloys may provide a yellowish background for the porcelain other metals they are cost prohibitive and alloys such as nickel, cobalt, palladium, etc., provide a gray background. For proper bonding, the alloying elements form an oxide on the cast metal surface. This dark gray to black colored oxide layer, can affect the apparent color of the porcelain veneering layer. The alloy system of the present invention includes elements added to regulate the amount and color of the oxide layer selected from the group including, but not limited to aluminum, boron, chromium, and/or silicon.

The mechanical properties of the alloy follow ANSI/ADA specification #38 and ISO standard IS9693 which require yield strength of at least 250 MPa for the alloy. To attain such strength, significant amounts of alloying elements selected from the group comprising, but not limited to, chromium, silicon, tantalum, titanium, and/or tungsten may be added to the alloy formulation.

The above mentioned standards do not require minimum or maximum values for coefficient of thermal expansion (CTE); however physical properties are required including the CTE value for both porcelain and alloy. The alloy of the invention includes elements added to regulate the grain size selected from the group including, but not limited to, chromium, gallium, tantalum, titanium, tungsten, rhenium and/or ruthenium.

Elements added to regulate oxidation during melting and casting includes but is not limited to, aluminum, boron, lithium, silicon. Also, heat transfer rate must be taken into consideration. When cooling from the porcelain firing temperature, shrinkage of both porcelain and alloy take place and the alloy, which cools faster, shrinks faster and thus puts tensile forces on the porcelain to metal bond. If this disparity of shrinkage is too much, the porcelain will no longer be bonded to the alloy when the composite reaches room temperature. It is readily understood that the solidus of the alloy must be sufficiently higher than the firing temperature of the porcelain so that the alloy is not even partially melted during firing.

Concerning the bonding of the porcelain to the alloy of the invention, it does not occur between porcelain and metal, it occurs between porcelain and the metal oxide layer formed when the alloy is heated prior to and during the firing of the porcelain. If the oxide is not adherent to the alloy, it can be simply removed by the porcelain. Some of the bond is simply mechanical but the primary bonding takes place as a mutual solution of metal oxide in porcelain and vice versa. If the oxide is not soluble in the porcelain and/or vice versa, no bond takes place.

While the invention has been described in detail, the following examples are for the purpose of illustration, it is understood that such detail is solely for that purpose, and variations can be made therein by those skilled in the art without departing from the spirit and scope of the invention which is defined by the following claims.

### EXAMPLES 1-7

### Coefficient of Thermal Expansion (CTE)

For successful use of the alloys of the invention with porcelains in contemporary use, the CTE should be in the range of about 14.0 to about 15.3. When two metals comprise the base of an alloy, it would be expected that the CTE of such an alloy be somewhere between the CTE's of the single metals. It has been determined that this does not hold necessarily true for alloys of palladium and cobalt. Whereas Pd has a CTE of 12.5 and Co 11.75, the alloys of the invention comprising Pd/Co have higher values as shown in the following examples:

| | 1 | 2 | 3 | 4 | 5 | 6 | 7 |
|---|---|---|---|---|---|---|---|
| Pd (wt. %) | 10 | 20 | 30 | 40 | 50 | 70 | 90 |
| Co (wt. %) | 90 | 80 | 70 | 60 | 50 | 30 | 10 |
| CTE | 13.85 | 14.0 | 14.1 | 14.6 | 14.9 | 15.2 | 14.2 |

### EXAMPLES 8-12

### Solidus

The minimum solidus temperature of the alloys of the invention is to determined to be about 1025° C. in order that the alloy does not start to melt during the firing of the porcelain on its surface.

| | 8 | 9 | 10 | 11 | 12 |
|---|---|---|---|---|---|
| Pd | 65 | 33.8 | 61.8 | 27.0 | 28.2 |
| Co | 35 | 60.4 | 14.9 | 52.3 | 56.0 |
| Cr | | | | 16.2 | 10.0 |
| Mo | | 2.4 | 2.0 | | |
| Si | | 1.0 | 0.7 | 0.6 | 0.05 |
| Fe | | | | | 3.0 |
| W | | | | | 2.0 |
| Ga | | | | | 0.35 |
| Al | | 1.2 | 1.6 | | |
| Ta | | | 0.8 | | |
| Cr | | | 1.2 | | |
| Nb | | | | 3.0 | |
| Re | | 0.6 | | | |
| Ru | | 0.6 | 0.8 | 0.5 | |
| Li | | | 0.1 | 0.1 | 0.2 |
| B | | | | | 0.2 |
| Solidus | 1219° C. | 1014° C. | 1250° C. | 976° C. | 1047° C. |

### Alloys 9 and 11 appear not to meet the required minimum solidus temperature.

### EXAMPLE 13

TYPE: Noble PFM/Type-4/ISO 9693
31-VI
Composition: Palladium: 28±0.80% ; Co: 55-58% ; Cr: 8.0-11.0% ; W: 2.5-4.0% ; Ga: 1.0-2.5% ; (Al, Si, B & Li: <1.0% ).
Density: 9.0 gm/cc
Color: Crucible:
WHITE Ceramic
Burn out Temperature: 750-820° C. (1380°-1510° F.)
Casting Temperature: 1410-1460° C. (2570-2660° F.)
Melting Temperature: 1100-1350° C. (2010-2460° F.)
Oxidation Cycle: 925° C./5 minute/AIR
Porcelain Compatibility: IPS d. Sign; IPS Classics & InLine.

| | Pore. Cycle: |
|---|---|
| Tensile Properties: | |
| U.T.S 0.2% offset Proof | 800 MPa 610 |
| Stress Percent | MPa 9.0% |
| Elongation Mod. Of | 175,000 MPa |
| Elasticity | 365 VHN |
| Hardness: | |
| C.T.E: @ 25–500° C. (2 > 20–600° C. | 14.2 × 10⁶/° C./inch/inch |
| | 14.8 × IO′VC/inch/inch |

What is claimed:

1. An alloy for a dental prostheses comprising a base metal consisting essentially of palladium and cobalt, and additives selected from the group consisting of aluminum, boron, chromium, gallium, lithium, rhenium, ruthenium, silicon, tantalum, titanium, tungsten or combinations thereof, wherein Palladium is 20 to 90 wt % , Cobalt is from 10 to 80 wt % , the additives from 0 to 20 wt % , the coefficient of thermal expansion for the alloy in the range of 14.0 to 15.2 at (25-500° C.).

2. The alloy of claim 1, wherein palladium is 30 to 43 wt. % , cobalt is 57 to 70 wt. % , the additives from 0 to 10 wt. % , the coefficient of thermal expansion from 14.0 to 14.7 (at 25-500° C.).

3. The alloy of claim 1, wherein palladium is 33 to 47 wt. % , cobalt is 53 to 67 wt. % , Cr is 2 to 20 wt. % , the additives from 0 to 10 wt. % , the coefficient of thermal expansion from 14.4 to 14.6 (at 25-500° C.).

4. The alloy of claim 1, wherein palladium is 27 to 30 wt. % , cobalt is 55 to 58 wt. % , chromium is 8 to 11 wt. % , tungsten is 2.5 to 4 wt. % , gallium is 1 to 2.5 wt. % , aluminum, silicon, boron and lithium o combinations thereof is less than 1 wt 5% , the coefficient of thermal exp % , aluminum, silicon, boron and lithium or combinations thereof is less than 1 wt. % , the coefficient of thermal expansion from 14.0 to 14.4 (at 25-500° C.).

5. The alloy of claim 1, wherein Pd is 28.2 wt % , Co is 56 wt % , Cr is 10 wt % , W is 3 wt % , Ga is 1.5 wt % and Al, Si, B, Li or a combination thereof is less than 1 wt. % , the coefficient of thermal expansion is 14.2 (at 25-500° C.).

6. A dental restoration including a dental crown or dental bridge comprising a dental porcelain composition fused to the alloy according to claim 1.
